(19) United States
(12) Patent Application Publication
(10) Pub. No.: US 2007/0278848 A1
(43) Pub. Date: Dec. 6, 2007

(54) Wheel rim

(75) Inventor: Chao-Ying Chen, Tainan Hsien (TW)

Correspondence Address: THE WEBB LAW FIRM, P.C., 700 KOPPERS BUILDING, 436 SEVENTH AVENUE, PITTSBURGH, PA, 15219, US

(73) Assignee: ALEX GLOBAL TECHNOLOGY, INC., Tainen Hsien (TW)

(21) Appl. No.: 11/447,827

(22) Filed: Jun. 6, 2006

(51) Int. Cl. B60B 21/06

(52) U.S. Cl. 301/58

(57) ABSTRACT

A wheel rim includes an annular base wall, annular left and right tire-retaining walls, and an annular reinforcing wall. The annular base wall includes an annular array of first through holes spaced apart from each other. The annular left and right tire-retaining walls are spaced apart from each other, and extend radially and outwardly from the annular base wall. The annular reinforcing wall includes an annular wall portion extending between the left and right tire-retaining walls and spaced apart from the annular base wall, and a plurality of hollow projections aligned radially and respectively with the first through holes. Each of the hollow projections defines a second through hole. Each of the hollow projections is formed as one piece with and projects from the annular wall portion of the annular reinforcing wall.

### BACKGROUND OF THE INVENTION

1. Field of the Invention

The invention relates to a wheel rim, more particularly to a wheel rim having a reinforced structure.

2. Description of the Related Art

Referring to FIGS. 1 and 2, a conventional wheel rim for a bicycle includes an annular base wall 21, annular left and right tire-retaining walls 23 spaced apart from each other and extending radially from the annular base wall 21, and an annular reinforcing wall 22 extending between the left and right tire-retaining walls 23 and spaced apart from the annular base wall 21. A tire 28 can be retained by the annular left and right tire-retaining walls 23. In order to position a plurality of spoke-retaining studs 26, each of which has a head 262 and a hollow shaft 261 extending from the head 262, in the wheel rim, the annular reinforcing wall 22 is provided with an annular array of first through holes 220, and the annular base wall 21 is provided with a plurality of second through holes 210 aligned radially and respectively with the first through holes 220. Each of the first through holes 220 has a size larger than that of the head 262 of each of the spoke-retaining studs 26, each of the second through holes 210 has a size smaller than that of each of the first through holes 220 and that of the head 262 of each of the spoke-retaining studs 26, and the shaft 261 of each of the spoke-retaining studs 26 has a size not larger than that of each of the second through holes 210. Therefore, each of the spoke-retaining studs 26 can pass through one of the first through holes 220, and can be positioned in a corresponding one of the second through holes 210 by passing the hollow shaft 261 of each of the spoke-retaining studs 26 through the corresponding one of the second through holes 210 such that the head 262 of each of the spoke-retaining studs 26 is limited by the annular base wall 21.

However, when assembling the spoke-retaining studs 26 in the wheel rim, it is difficult to position the spoke-retaining studs 26 in the second through holes 210 precisely and correspondingly through the first through holes 220 such that some of the spoke-retaining studs 26 may fall into a space 20 between the base wall 21 and the reinforcing wall 22.

Referring to FIGS. 3 and 4, in order to overcome the shortcoming of the aforesaid prior art, Taiwanese Utility Publication No. 376,033 discloses a wheel rim in which a plurality of guide tubes 27 are assembled between the annular base wall 21 and the annular reinforcing wall 22 and are aligned with the first and second through holes 220, 210 correspondingly. However, assembling the guide tubes 27 in the wheel rim through the first through holes 220 of the reinforcing wall 22 is time-consuming. Furthermore, the presence of the guide tubes 27 increases the overall weight of the wheel rim.

Referring to FIGS. 5 and 6, in another conventional wheel rim, the guide tubes 27 are riveted between the annular base wall 21 and the annular reinforcing wall 22 and are aligned with the first and second through holes 220,210 correspondingly. Since the guide tubes 27 are riveted between the annular base wall 21 and the annular reinforcing wall 22, the process for making the wheel rim is relatively complicated. Similarly, the overall weight of the wheel rim is increased due to the presence of the guide tubes 27.

Additionally, U.S. Pat. No. 6,402,256 B1 disclosed a bicycle rim including an upper bridge, a lower bridge, and side walls. The lower bridge has holes for spoke connection purposes.

### SUMMARY OF THE INVENTION

The object of the present invention is to provide a wheel rim, which can be assembled relatively simply and easily.

Accordingly, in one aspect of this invention, a wheel rim includes an annular base wall, annular left and right tire-retaining walls, and an annular reinforcing wall. The annular base wall includes an annular array of first through holes spaced apart from each other. The annular left and right tire-retaining walls are spaced apart from each other, and extend radially and outwardly from the annular base wall. The annular reinforcing wall includes an annular wall portion extending between the left and right tire-retaining walls and spaced apart from the annular base wall, and a plurality of hollow projections aligned radially and respectively with the first through holes. Each of the hollow projections defines a second through hole. Each of the hollow projections is formed as one piece with and projects from the annular wall portion of the annular reinforcing wall.

In another aspect of this invention, a wheel rim includes an annular base wall, annular left and right tire-retaining walls, an annular reinforcing wall, and a plurality of spoke-retaining studs. The annular base wall includes an annular array of first through holes spaced apart from each other. The annular left and right tire-retaining walls are spaced apart from each other and extend radially and outwardly from the annular base wall. The annular reinforcing wall includes an annular wall portion extending between the left and right tire-retaining walls and spaced apart from the annular base wall, and a plurality of hollow projections aligned radially and respectively with the first through holes. Each of the hollow projections defines a second through hole. Each of the spoke-retaining studs extends through one of the first through holes from one of said hollow projections, and has a head retained in said one of the hollow projections. Each of the hollow projections is formed as one piece with and projects from the annular wall portion of the annular reinforcing wall.

### BRIEF DESCRIPTION OF THE DRAWINGS

Other features and advantages of the present invention will become apparent in the following detailed description of the preferred embodiments with reference to the accompanying drawings, of which:

FIG. 1 is a cross-sectional view of a first conventional wheel rim;

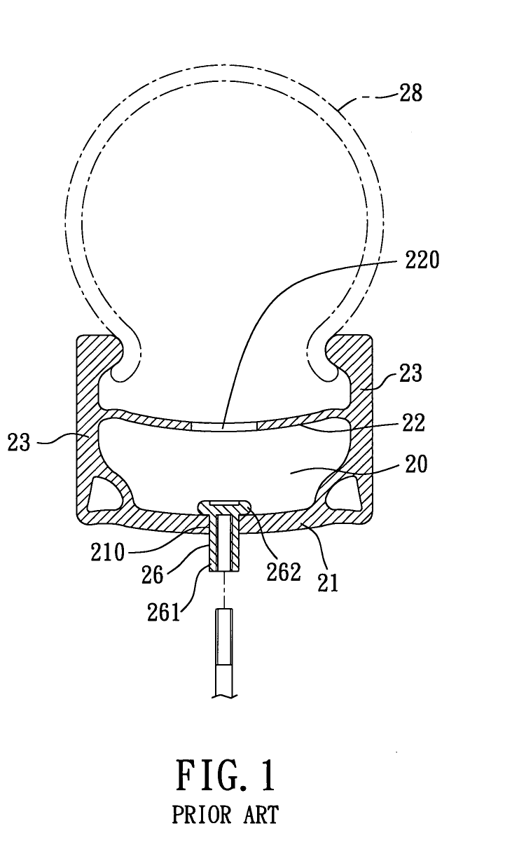

FIG. 2 is another cross-sectional view of the first conventional wheel rim;

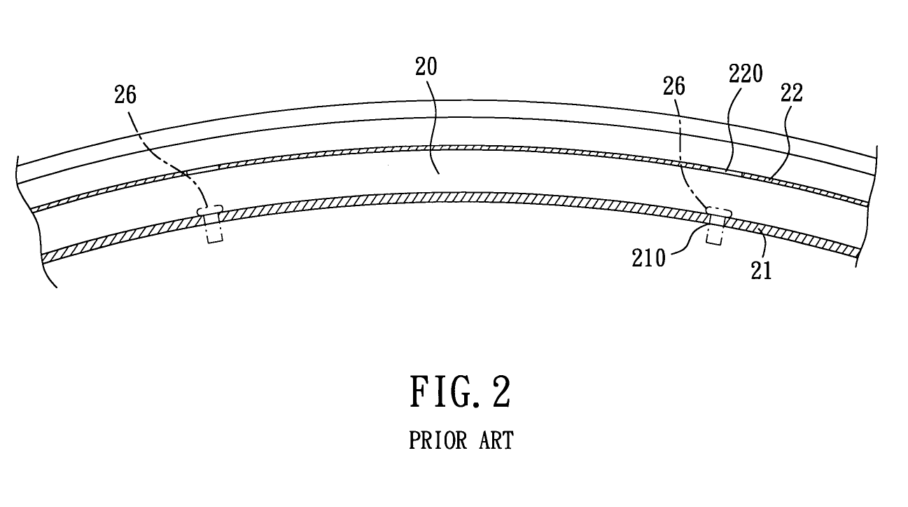

FIG. 3 is a cross-sectional view of a second conventional wheel rim;

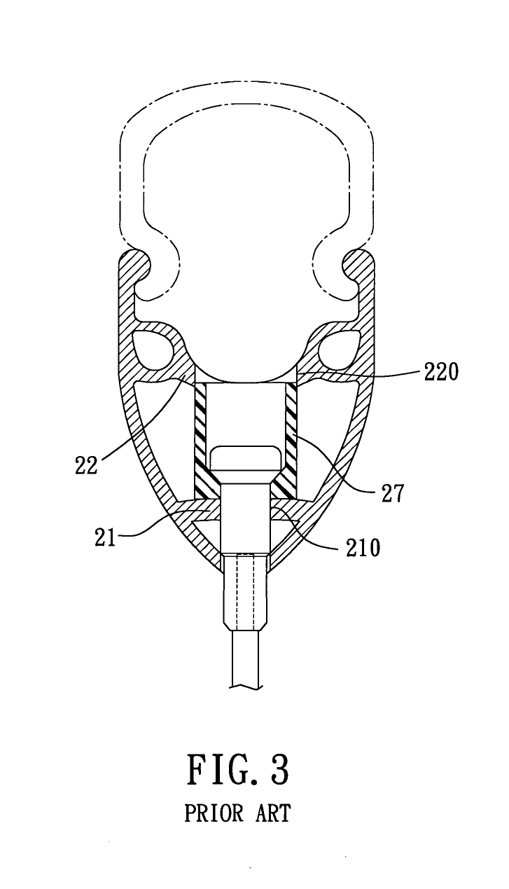

FIG. 4 is another cross-sectional view of the second conventional wheel rim;

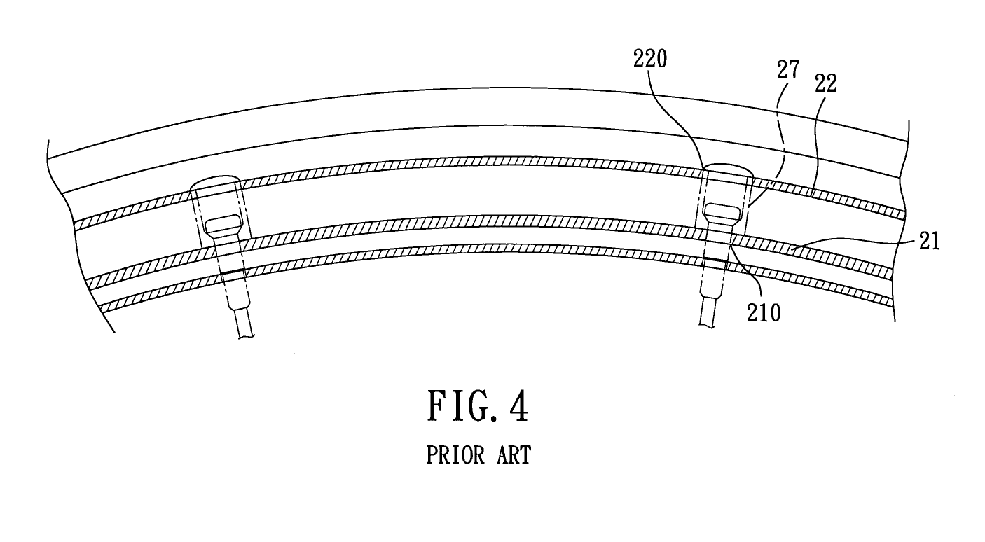

FIG. 5 is a cross-sectional view of a third conventional wheel rim;

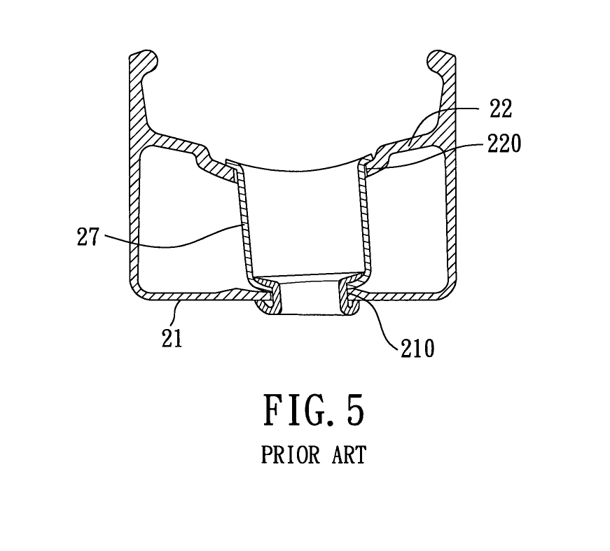

FIG. 6 is another cross-sectional view of the third conventional wheel rim;

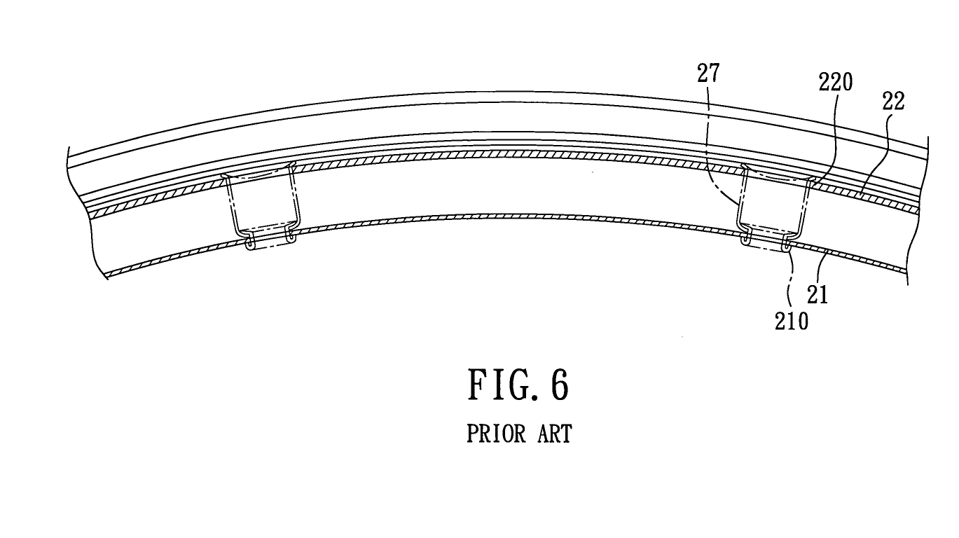

FIG. 7 is a perspective view of the first preferred embodiment of a wheel rim according to this invention;

FIG. 8 is an exploded fragmentary perspective view of the first preferred embodiment;

FIG. 9 is a cross-sectional view of the first preferred embodiment;

FIG. 10 is another cross-sectional view of the first preferred embodiment;

FIG. 11 is a flowchart of the preferred embodiment of a method for making a wheel rim according to this invention;

FIG. 12 are cross-sectional views illustrating consecutive steps of the preferred embodiment of FIG. 11; and

FIG. 13 is a cross-sectional view of the second preferred embodiment of a wheel rim according to this invention.

### DETAILED DESCRIPTION OF THE PREFERRED EMBODIMENTS

Before the present invention is described in greater detail, it should be noted that like elements are denoted by the same reference numerals throughout the disclosure.

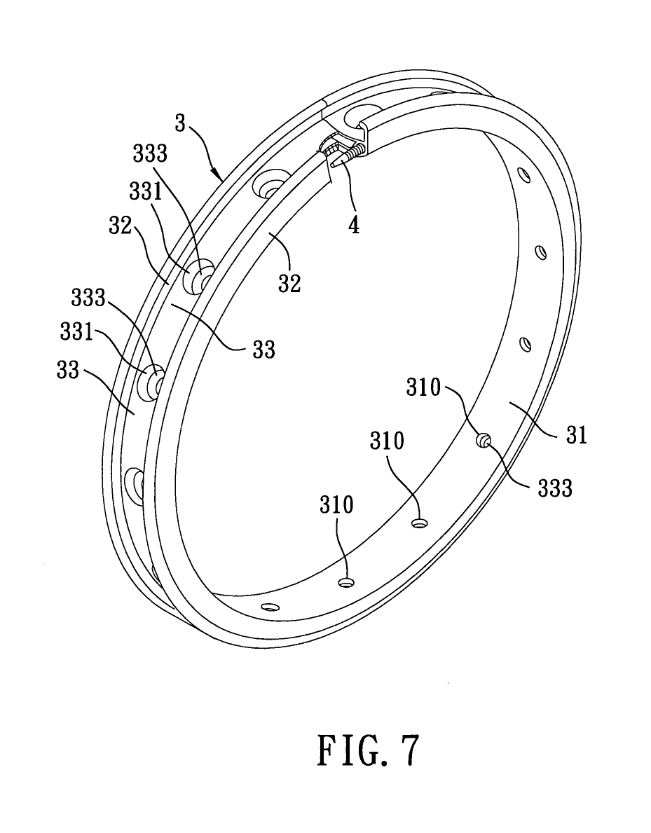

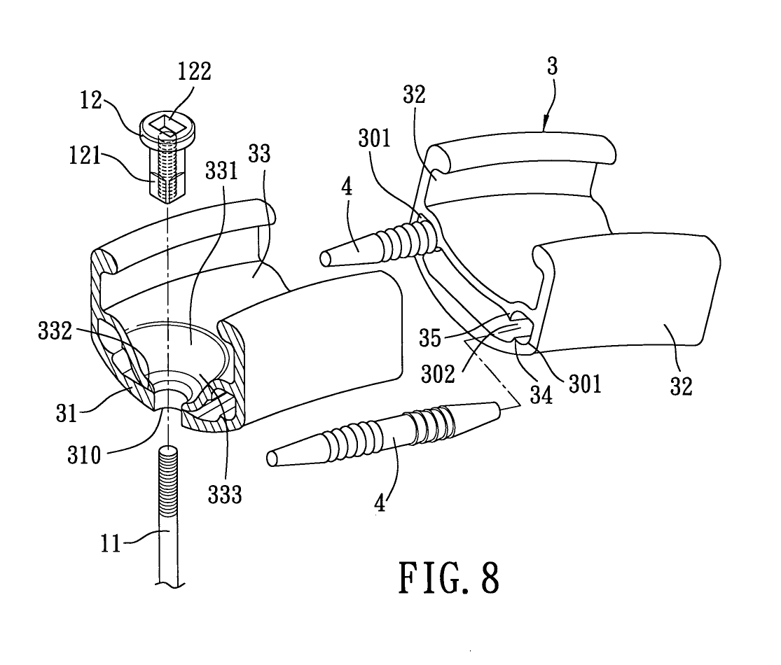

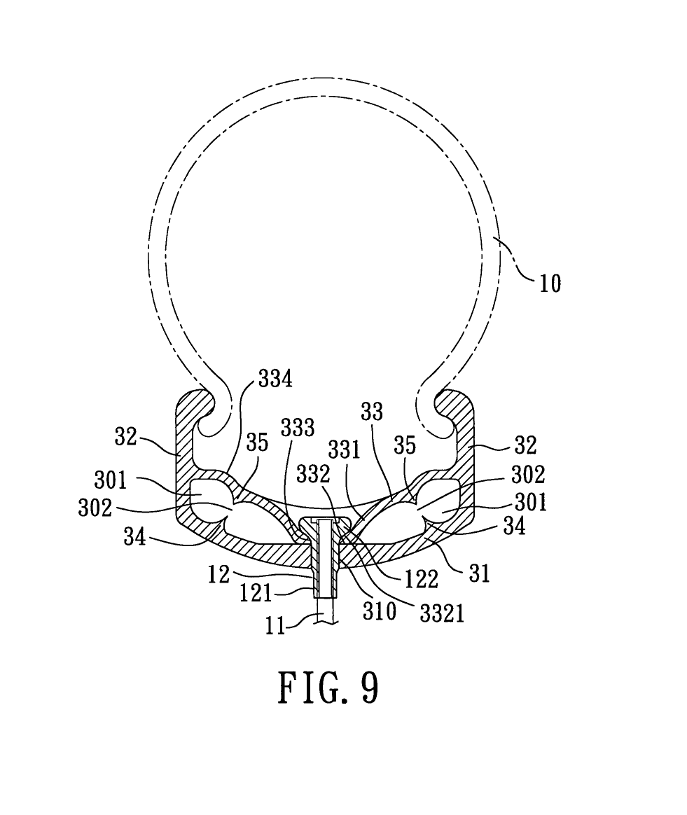

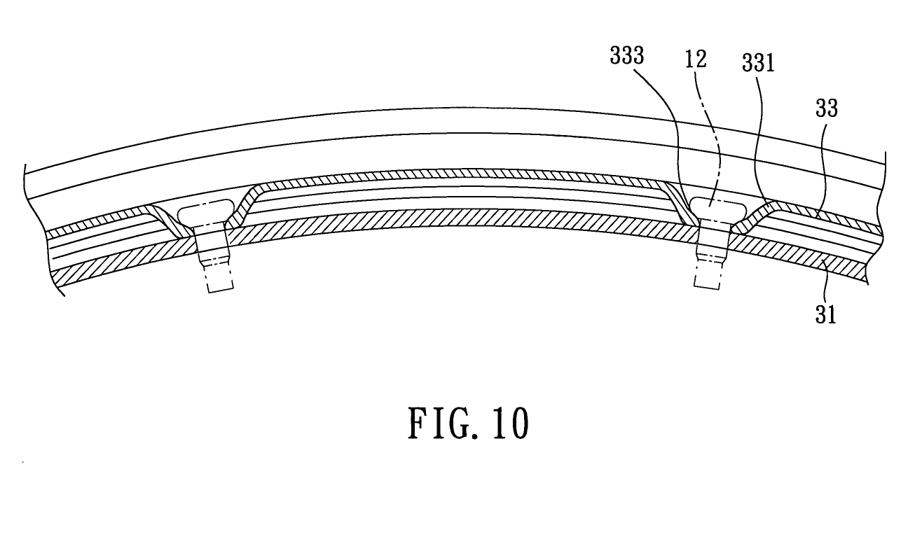

Referring to FIGS. 7, 8, 9, and 10, the first preferred embodiment of a wheel rim according to this invention is used for assembly with a tire 10 and a plurality of spokes 11, and includes a wheel rim body 3 and two engaging pins 4.

The wheel rim body 3 includes an annular base wall 31, annular left and right tire-retaining walls 32, an annular reinforcing wall 33, and a plurality of spoke-retaining studs 12.

The annular base wall 31 includes an annular array of first through holes 310 spaced apart from each other, and two first annular rib portions 34 extending along the length of the annular base wall 31 on two sides of the annular array of the first through holes 310, and protruding from the annular base wall 31 toward the annular reinforcing wall 33.

The annular left and right tire-retaining walls 32 are used for retaining the tire 10, and are spaced apart from each other and extend radially and outwardly from the annular base wall 31.

The annular reinforcing wall 33 includes an annular wall portion 334 extending between the left and right tire-retaining walls 32 and spaced apart from the annular base wall 31, and a plurality of hollow projections 331 aligned radially and respectively with the first through holes 310. Each of the hollow projections 331 defines a second through hole 333. The annular reinforcing wall 33 further includes two second annular rib portions 35 extending along the length of the annular reinforcing wall 33, and protruding from the annular reinforcing wall 33 toward the first annular rib portions 34. Each of the first annular rib portions 34 cooperates with a corresponding one of the second annular rib portions 35 and a corresponding one of the left and right tire-retaining walls 32 to define an engaging channel 301 in which a corresponding one of the engaging pins 4 can be inserted. The first annular rib portions 34 are spaced apart from the second annular rib portions 35, respectively, so that each of the first annular rib portions 34 further cooperates with the corresponding one of the second annular rib portions 35 to define a space 302 therebetween.

Each of the spoke-retaining studs 12 is used for retaining a corresponding one of the spokes 11, and extends through one of the first through holes 310 from one of the hollow projections 331, and has a head 122 retained in said one of the hollow projections 331, and a hollow threaded shaft 121 protruding from the head 122 through said one of the first through holes 310.

Each of the hollow projections 331 is a punched portion that is formed as one piece with and that projects from the annular wall portion 334 of the annular reinforcing wall 33, and that tapers from the annular wall portion 334 of the reinforcing wall 33 towards the annular base wall 31. The second through hole 333 of each of the hollow projections 331 has a smallest cross section smaller than that of the head 122 of a corresponding one of the studs 12, and substantially equal to that of each of the first through holes 310. Each of the hollow projections 331 has an end portion 332 abutting against the annular base wall 31. The end portion 332 includes an inner annular rib 3321 projecting into the second through hole 333 and retaining the head 122 of a corresponding one of the spoke-retaining studs 12 thereon.

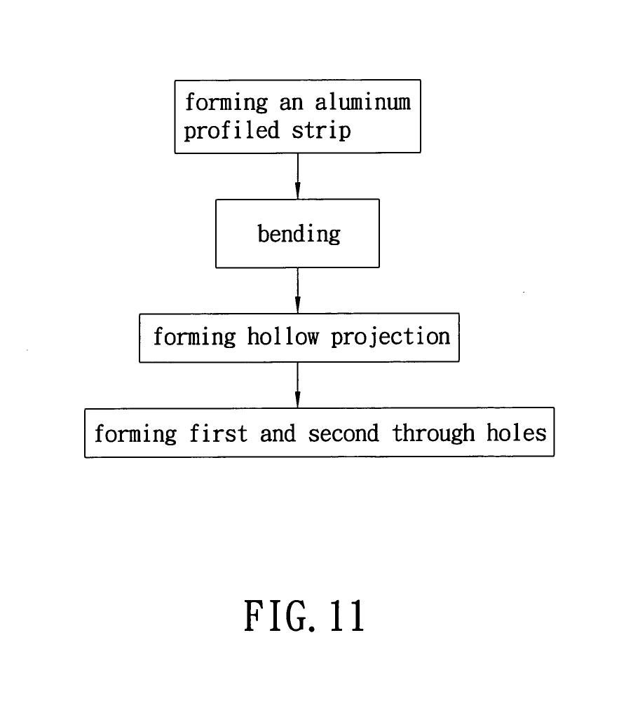

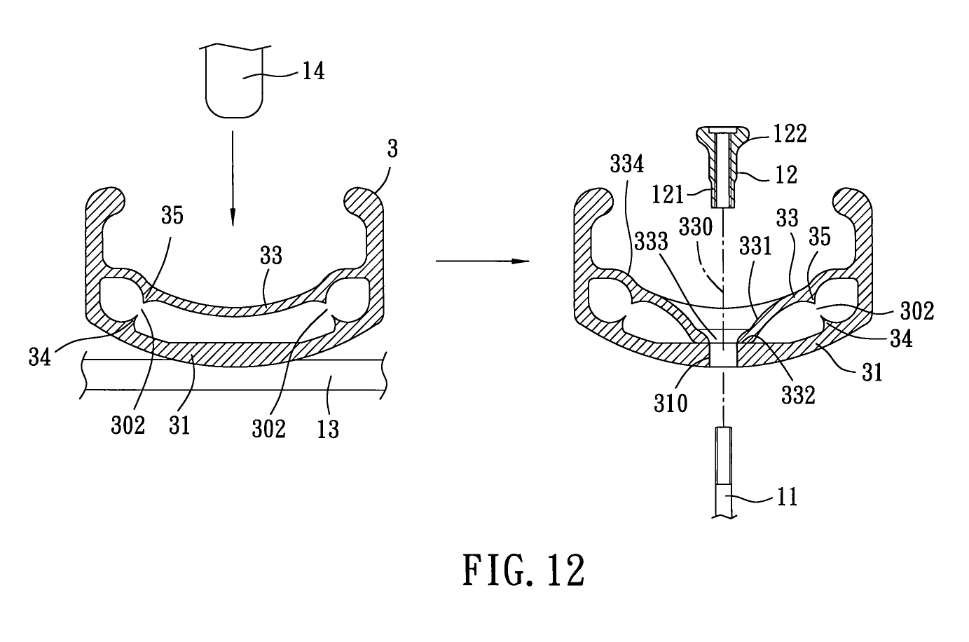

Referring to FIGS. 11 and 12, the preferred embodiment of a method for making the wheel rim of this invention includes the steps of:

(1) Forming an Aluminum Profiled Strip:

An aluminum profiled strip is formed integrally by extrusion.

(2) Bending:

The strip is bent to form a circular body. Two ends of the circular body are engaged to each other using the engaging pins 4 to form the wheel rim body 3.

(3) Forming the Hollow Projections 331:

The annular base wall 31 of the wheel rim body 3 is disposed on a worktable 13, and the annular reinforcing wall 33 is punched repeatedly at predetermined intervals using a punch 14 so as to form a plurality of the hollow projections 331 formed as one piece with the annular wall portion 334 of the annular reinforcing wall 33 along the length of the annular reinforcing wall 33. The end portion 332 of each of the hollow projections 331 abuts against the annular base wall 31. Since there is the space 302 provided between each of the first annular rib portions 34 and the corresponding one of the second annular rib portions 35, the first and second annular rib portions 34, 35 are not deformed during punching.

(4) Forming the First and Second Through Holes 310, 333:

Each of the hollow projections 331 is further punched along a radial axis 330 so that the annular wall portion 334 of the annular reinforcing wall 33 is formed with a plurality of the second through holes 333, and so that the annular base wall 31 is formed with a plurality of the first through holes 310 corresponding to the second through holes 333.

During assembly, the hollow threaded shaft 121 of each of the spoke-retaining studs 12 is inserted through one of the second through holes 333 and the corresponding one of the first through holes 310 until the head 122 of each of the spoke-retaining studs 12 is retained on the inner annular rib 3321 of the end portion 332 in a corresponding one of the hollow projections 331. Finally, each of the spokes 11 are engaged to the hollow threaded shaft 121 of a corresponding one of the spoke-retaining studs 12.

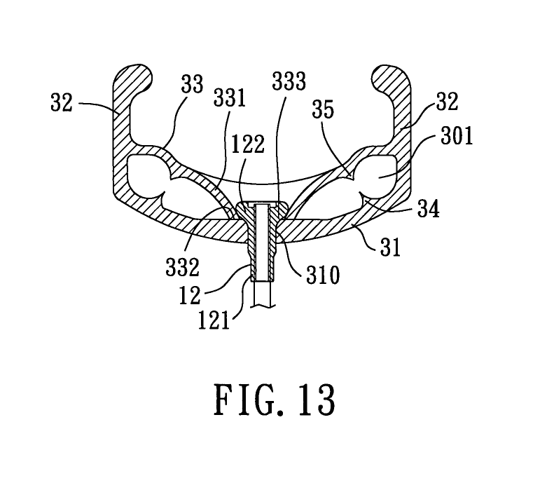

Referring to FIG. 13, the second preferred embodiment of a wheel rim according to this invention is similar to the first preferred embodiment, except that the second through hole 333 of each of the hollow projections 331 has a smallest cross section larger than that of each of the first through holes 310. The cross section of each of the first through holes 310 is smaller than that of the head 122 of each of the spoke-retaining studs 12. Therefore, the head 122 of each of the spoke-retaining studs 12 is limited by the annular base wall 31, and is retained in a corresponding one of the hollow projections 331.

In view of the aforesaid, each of the hollow projections 331 is used as a guide channel to guide each of the spoke-retaining studs 12 relatively easily through the second through hole 333 and the corresponding first through hole 310. Therefore, the shortcoming of the prior art can be overcome. Additionally, since the hollow projections 331 are formed as one piece with the annular reinforcing wall 33, the additional guide tubes required in the prior art can be omitted. Moreover, the hollow projections 331 also enhance the structural strength of the wheel rim.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A wheel rim, comprising:
an annular base wall including an annular array of first through holes spaced apart from each other;
annular left and right tire-retaining walls spaced apart from each other and extending radially and outwardly from said annular base wall; and
an annular reinforcing wall including an annular wall portion extending between said left and right tire-retaining walls and spaced apart from said annular base wall, and a plurality of hollow projections aligned radially and respectively with said first through holes, each of said hollow projections defining a second through hole;
wherein each of said hollow projections is formed as one piece with and projects from said annular wall portion of said annular reinforcing wall.

2. The wheel rim as claimed in claim 1, wherein said second through hole of each of said hollow projections has a smallest cross section larger than that of each of said first through holes.

3. The wheel rim as claimed in claim 1, wherein each of said hollow projections is a punched portion tapering from said annular wall portion of said reinforcing wall towards said annular base wall.

4. The wheel rim as claimed in claim 1, wherein each of said hollow projections has an end portion abutting against said annular base wall.

5. The wheel rim as claimed in claim 4, wherein said end portion includes an inner annular rib projecting into said second through hole.

6. The wheel rim as claimed in claim 1, wherein said annular base wall further includes two first annular rib portions extending along the length of said annular base wall on two sides of said annular array of said first through holes, and protruding from said annular base wall toward said annular reinforcing wall, said annular reinforcing wall further including two second annular rib portions extending along the length of said annular reinforcing wall, and protruding from said annular reinforcing wall toward said first annular rib portions, said first annular rib portions being spaced apart from said second annular rib portions, respectively, each of said first annular rib portions cooperating with a corresponding one of said second annular rib portions and a corresponding one of said left and right tire-retaining walls to define an engaging channel.

7. A wheel rim, comprising:
an annular base wall including an annular array of first through holes spaced apart from each other;
annular left and right tire-retaining walls spaced apart from each other and extending radially and outwardly from said annular base wall;
an annular reinforcing wall including an annular wall portion extending between said left and right tire-retaining walls and spaced apart from said annular base wall, and a plurality of hollow projections aligned radially and respectively with said first through holes, each of said hollow projections defining a second through hole; and
a plurality of spoke-retaining studs each extending through one of said first through holes from one of said hollow projections, and each having a head retained in said one of said hollow projections,
wherein each of said hollow projections is formed as one piece with and projects from said annular wall portion of said annular reinforcing wall.

8. The wheel rim as claimed in claim 7, wherein each of said hollow projections is a punched portion tapering from said annular wall portion of said reinforcing wall towards said annular base wall.

9. The wheel rim as claimed in claim 7, wherein said second through hole of each of said hollow projections has a smallest cross section larger than that of each of said first through holes.

10. The wheel rim as claimed in claim 7, wherein each of said hollow projections has an end portion abutting against said annular base wall.

11. The wheel rim as claimed in claim 10, wherein said end portion includes an inner annular rib projecting into said second through hole and retaining said head of a corresponding one of said spoke-retaining studs thereon.

12. The wheel rim as claimed in claim 7, wherein said annular base wall further includes two first annular rib portions extending along the length of said annular base wall on two sides of said annular array of said first through holes, and protruding from said annular base wall toward said annular reinforcing wall, said annular reinforcing wall further including two second annular rib portions extending along the length of said annular reinforcing wall, and protruding from said annular reinforcing wall toward said first annular rib portions, said first annular rib portions being spaced apart from said second annular rib portions, respectively, each of said first annular rib portions cooperating with a corresponding one of said second annular rib portions and a corresponding one of said left and right tire-retaining walls to define an engaging channel.
